(19) United States
(12) Patent Application Publication
(10) Pub. No.: US 2005/0149448 A1
(43) Pub. Date: Jul. 7, 2005

(54) Music content acquisition apparatus

(75) Inventors: Tsutomu Yanase, Hamamatsu-shi (JP); Takeshi Komano, Iwata-shi (JP)

Correspondence Address: MORRISON & FOERSTER, LLP, 555 WEST FIFTH STREET, SUITE 3500, LOS ANGELES, CA, 90013-1024, US

(73) Assignee: YAMAHA CORPORATION, Hamamatsu-shi (JP)

(21) Appl. No.: 11/022,107

(22) Filed: Dec. 23, 2004

(30) Foreign Application Priority Data
Jan. 7, 2004 (JP) 2004-002463

(51) Int. Cl. H04K 1/00; H04L 9/00; G06F 17/60; G10H 1/06; G10H 7/00

(52) U.S. Cl. 705/56

(57) ABSTRACT

An information acquisition apparatus is capable of associating with a target electronic music apparatus and capable of acquiring content information representing a music content from a contents distribution site for use in the target electronic music apparatus. In the information acquisition apparatus, an information reception section receives content information representing a music content desired for the target electronic music apparatus from the contents distribution site through a communication line. An ID acquisition section acquires identification information which uniquely identifies the target electronic music apparatus from other electronic music apparatuses. An embedding section embeds the acquired identification information into the received content information. A control section records the content information embedded with the identification information into a recording medium for use in the target electronic musical apparatus.

### BACKGROUND OF THE INVENTION

1. Technical Field

The present invention relates to a content acquisition system for acquiring a music content for use in an electronic music apparatus. The system is adapted, when the music content is provided from a contents distribution site via a communication terminal, to take effective security measures at the stage of capturing the provided music content by a communication terminal.

2. Related Art

Systems are known for acquiring a music content, such as music program, song data, and style data, for use in a terminal type of electronic music apparatuses from contents distribution sites, and the acquired music content is used on the terminal type of the electronic music apparatus. In these systems, as disclosed in patent document 1 indicated below for example, the security of music content acquired by the terminal type of the electronic music apparatus (namely, a user terminal, such as a personal computer or a wireless mobile terminal having music content reproducing capabilities) is provided by embedding a device ID (or machine ID) of the terminal type of the electronic music apparatus so as to make the music content acquired from a server (or contents distribution site) available only on the electronic music apparatus terminal (or the user terminal) that has actually acquired this music content. The patent document 1 is Japanese Patent No. 3262121. The related art is disclosed at paragraph [0032] of the patent document 1.

On the other hand, there are demands for first acquiring music content provided by contents distribution sites by a communication terminal, such as a personal computer having communication capabilities or a mobile phone terminal, then storing the acquired music content into a predetermined portable recording medium, such as a detachable semiconductor memory card, and using the stored music content on a separate electronic music apparatus, such as an electronic music instrument, through the portable recording medium. Further, there are demands for using music content acquired by a communication terminal in a separate electronic music apparatus through a local communication medium, such as a cable.

However, the above-mentioned usage form of the music content cannot enjoy the conventional security measures supported by the above-mentioned related-art technique, because the content is acquired by a terminal apparatus separate from and other than a target electronic music apparatus. As mentioned above, the music content acquired by the communication terminal other than the target electronic music apparatus which is intended to use the music content is once stored in a recording medium before being passed to the target electronic music apparatus or is passed thereto via a communication medium. If protection is applied to the stored or passed music content, the target electronic music apparatus could not freely use the music content because of the protection applied to the music content.

### SUMMARY OF THE INVENTION

It is therefore an object of the present invention to provide a content acquisition system for acquiring music content for use in an electronic music apparatus, the system being capable of effectively taking security measures for the content even if acquired by an apparatus other than the target electronic music apparatus that is intended to use the content.

In carrying out the invention and according to one aspect thereof, there is provided an information acquisition apparatus capable of associating with a target electronic music apparatus and capable of acquiring content information representing a music content from a contents distribution site for use in the target electronic music apparatus. The inventive information acquisition apparatus comprises an information reception section that receives content information representing a music content desired for the target electronic music apparatus from the contents distribution site through a communication line, an ID acquisition section that acquires identification information which uniquely identifies the target electronic music apparatus from other electronic music apparatuses, an embedding section that embeds the acquired identification information into the received content information, and a control section that records the content information embedded with the identification information into a recording medium for use in the target electronic musical apparatus.

Preferably, the control section records the content information into a recording medium which is previously recorded with the identification information of the target electronic musical apparatus, and the ID acquisition section acquires the identification information by reading the recording medium.

Preferably, the inventive information acquisition apparatus further comprises a storage unit that stores the identification information which is previously provided from the target electronic musical apparatus, so that the ID acquisition section acquires the identification information by reading the storage unit.

Preferably, the control section records the content information embedded with the identification information into a recording medium, which is then loaded into the target electronic musical apparatus, whereby the target electronic musical apparatus can use the content information recorded in the loaded recording medium only if the embedded identification information in the content information matches with unique identification information owned by the target electronic music apparatus.

Preferably, the inventive information acquisition apparatus further comprises a requesting section that is operated to request acquisition of the identification information, so that the ID acquisition section acquires the identification information in response to the request. In this case, the control section discards the received content information when the ID acquisition section fails to acquire the identification information in response to the request.

In carrying out the invention and according to another aspect thereof, there is provided an information acquisition apparatus capable of communicating with a target electronic music apparatus and capable of acquiring content information representing a music content from a contents distribution site for use in the target electronic music apparatus. The inventive information acquisition apparatus comprises an information reception section that receives content information representing a music content desired for the target electronic music apparatus from the contents distribution site through a communication line, an ID acquisition section that acquires identification information which uniquely identifies the target electronic music apparatus from other electronic music apparatuses, an embedding section that embeds the acquired identification information into the received content information, and a transmission section that transmits the content information embedded with the identification information to the target electronic musical apparatus.

Preferably, the inventive information acquisition apparatus further comprises a requesting section that requests the identification information to the target electronic music apparatus, so that the ID acquisition section acquires the identification information which is sent from the target electronic music apparatus in response to the request. In this case, the inventive information acquisition apparatus further comprises a control section that discards the received content information when the ID acquisition section fails to acquire the identification information in response to the request.

Preferably, the transmission section transmits the content information embedded with the identification information to the target electronic musical apparatus, whereby the target electronic musical apparatus can use the transmitted content information if the embedded identification information in the content information matches with unique identification information owned by the target electronic music apparatus.

In carrying out the invention and according to a further aspect thereof, there is provided a computer program for use in an information acquisition apparatus capable of associating with a target electronic music apparatus and capable of acquiring content information representing a music content from a contents distribution site for use in the target electronic music apparatus. The inventive computer program is executable by a processor of the information acquisition apparatus to perform a method comprising the steps of receiving content information representing a music content desired for the target electronic music apparatus from the contents distribution site through a communication line, acquiring identification information which uniquely identifies the target electronic music apparatus from other electronic music apparatuses, embedding the acquired identification information into the received content information, and recording the content information embedded with the identification information into a recording medium for use in the target electronic musical apparatus.

In carrying out the invention and according to a still further aspect thereof, there is provided a computer program for use in an information acquisition apparatus capable of communicating with a target electronic music apparatus and capable of acquiring content information representing a music content from a contents distribution site for use in the target electronic music apparatus. The inventive computer program is executable by a processor of the information acquisition apparatus for performing a method comprising the steps of receiving content information representing a music content desired for the target electronic music apparatus from the contents distribution site through a communication line, acquiring identification information which uniquely identifies the target electronic music apparatus from other electronic music apparatuses, embedding the acquired identification information into the received content information, and transmitting the content information embedded with the identification information to the target electronic musical apparatus.

In the content acquisition system for acquiring content for use in an electronic music apparatus according to the invention, the content acquisition apparatus, such as a personal computer, is a communication terminal that is communicable with a contents distribution site via a communication network, such as the Internet. On the other hand, the target electronic music apparatus, such as an external electronic music instrument, can use such contents as various music information processing programs, music instrument setting information, and music entity information without being connected to this communication network. If a terminal user wants to acquire the above-mentioned content for use in an external electronic music apparatus, the terminal user accesses a contents distribution site to download the desired content for the electronic music apparatus onto his content acquisition apparatus through a procedure described below.

Namely, the content acquisition apparatus receives the content for use in the target electronic music apparatus from the contents distribution site, then temporarily stores the received content, and requests a device ID unique to the target electronic music apparatus that is intended to use this content. If, in response to this request, this device ID of the electronic music apparatus is successfully obtained because this device ID of the electronic music apparatus is in such obtainable state as that a recording medium storing the device ID of the electronic music apparatus is loaded on the content acquisition apparatus or the content acquisition apparatus is connected to the electronic music apparatus via a local communication medium for example, then the received content for use in the electronic music apparatus can be acquired (or downloaded).

In this process, the device ID is embedded in the received content, which is then stored in a predetermined memory medium or transferred to the electronic music apparatus. Obviously, if the recording medium storing the device ID is not loaded or the content acquisition apparatus is not connected to the electronic music apparatus, namely, if the device ID is not in the obtainable state, then the embedding of the device ID or the storage or transfer of the content embedded with the device ID are not executed.

To be more specific, according to the invention, only when the content acquisition apparatus receives the music content for use in a target electronic music apparatus from a contents distribution site, requests the acquisition of the device ID unique to the target electronic music apparatus, and gets the requested device ID via a recording medium or a communication medium. The acquired device ID is embedded in the received content for the electronic music apparatus. The resultant content is stored in a predetermined recording medium or passed to the electronic music apparatus. In addition, if a device ID acquisition condition cannot be satisfied, thereby disabling the acquisition of the received content (because the device ID has not been received from the electronic music apparatus via medium or the electronic music apparatus is not connected to the content acquisition apparatus, for example), then the received content for use in the electronic music apparatus is neither stored in a recording medium nor passed to the electronic music apparatus.

Consequently, according to the invention, only when the device ID of the electronic music apparatus is available in the content acquisition apparatus, the content for use in the electronic music apparatus can be acquired. If there is no device ID in the content acquisition apparatus, the content for use in an electronic music apparatus cannot be acquired and the content acquisition condition is restricted so as to prevent the content from being stored in a recording medium or being transferred to the electronic music apparatus, thereby preventing the inadvertent downloading of the content. Because the acquired content for use in the electronic music apparatus has the device ID unique to the electronic music apparatus that is intended to use this content, security can be provided so that only the electronic music apparatus concerned can use the content. Therefore, if any apparatus other than the electronic music apparatus concerned acquires this content for use in an electronic music apparatus, such apparatus cannot use the acquired content, thereby providing effective security measures.

### BRIEF DESCRIPTION OF THE DRAWINGS

FIG. 1 is a block diagram illustrating a hardware configuration of a content acquisition system practiced as one embodiment of the invention.

FIGS. 2(A) and 2(B) are flowcharts indicative of exemplary processing operations of a content acquisition apparatus (or a personal computer) and an electronic music apparatus in the above-mentioned system.

### DETAILED DESCRIPTION OF THE INVENTION

The following describes embodiments of the present invention with reference to drawings. It should be noted that the following embodiment is illustrative only and various modifications thereto may be made as along as they will not depart from the spirit of the present invention.

[System Overview]

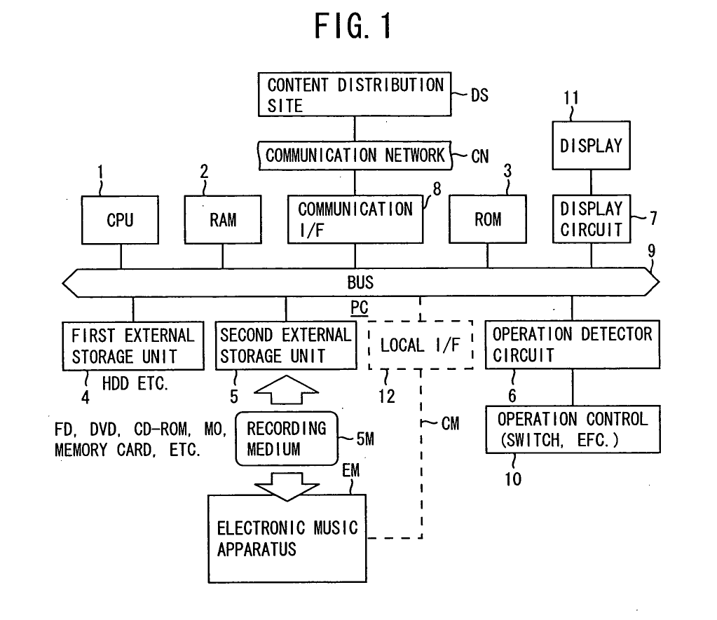

Now, referring to FIG. 1, there is shown a block diagram illustrating a hardware configuration of a content acquisition system practiced as one embodiment of the invention. The content acquisition system is composed of a contents distribution site, a content acquisition apparatus PC and an electronic music apparatus EM. In this example, a communication terminal that functions as a the content acquisition apparatus PC is based on an information processing apparatus, such as a personal computer having communication capabilities for communicating with the contents distribution site DS.

The content acquisition apparatus, or the personal computer PC, has a central processing unit (CPU) 1, a random memory (RAM) 2, a read-only memory (ROM) 3, a first external storage unit 4, a second external storage unit 5, an operation detector circuit 6, a display circuit 7, and a communication interface (I/F) 8, which are interconnected through a bus 9.

The CPU 1 executes various processing operations including content acquisition in accordance with various control programs including application software, such as a content acquisition program. The RAM 2 is used as a work area for temporarily storing various data necessary for the execution by the CPU 1; for example, a storage area for use as a temporary memory in which music content sent from the contents distribution site DS is temporarily stored is allocated in the RAM 2. The ROM 3 stores various control programs for executing the above-mentioned various processing operations and the data necessary for the execution.

The first external storage unit 4 has an internal recording medium, such as a hard disk (HD). The second external storage unit 5 drives a portable external recording medium to access this recording medium for reading or writing predetermined information. The portable external storage media include compact disk read-only memory (CD-ROM), flexible disk (FD), magneto-optical disk (MO), digital versatile disk (DVD), small-size memory card such as Smart Media (trademark), and so on. One of these portable external storage media, a predetermined portable external storage media 5M to which the device ID of the electronic music apparatus concerned is written is used as “particular recording medium” for storing the music content sent from the contents distribution site DS.

The operation detector circuit 6 and an operator control 10 connected thereto form an operation input block, in which the operation of the operator control 10, such as key switch or mouse, is detected by the operation detector circuit 6 and the setting information corresponding to the detection is inputted in the system main.

The display circuit 7 and a display 11 connected thereto and various indicators (or lamps) form a display output block. The display circuit 7 controls the screen display status on the display 11 and the indicator on/off status as directed by the CPU 1, thereby displaying the information that helps the user in his operation of the operator control 10. It should be noted that, as required, a voice output block may be arranged for the means to make communication with the user, in addition to the display circuit 7 and the display 11.

The communication interface (I/F) 8 connects to a communication network CN, such as the Internet, thereby receiving content from the contents distribution site or other servers (not shown) connected to the communication network CN to store the received content into the first external storage unit 4 or the second external storage unit 5.

Especially, the content received from the contents distribution site DS includes such content that is used by the personal computer PC itself as the content acquisition program and the music content that is used by the electronic music apparatus EM. The music content includes music data called song data, accompaniment pattern data called style data, music entity data representative of the contents of music, such as musical note data to be used for the display processing by the electronic music apparatus EM, and various music information processing programs for executing various music information processing on the basis of these items of information.

For receiving the above-mentioned music content from the contents distribution site DS, the portable external recording medium 5M to be used as a particular recording medium may be loaded on the second external storage unit 5 in advance, thereby storing the music content received from the contents distribution site DS into the portable external recording medium 5M in accordance with the content acquisition program.

As indicated with dashed lines in FIG. 1, the personal computer PC can communicate with the electronic music apparatus EM via a cable, such as USB or MIDI, or a local communication medium CM, such as in-house radio, by arranging a local communication medium CM, as required. In this case, when the device ID of the electronic music apparatus EM has been acquired at the reception of music content from the contents distribution site DS, the distributed music content can be transferred to the electronic music apparatus EM or stored in the built-in recording medium of the first external storage unit 4 in accordance with the content acquisition program.

In the present system, the contents distribution site DS includes the server capabilities of site management and therefore is used in substantially the same sense as “content distribution server”. The hardware configuration of this content distribution server DS is substantially the same as that of the personal computer PC shown in FIG. 1 and has a large-scale external storage unit, not shown. This external storage unit stores many music content files. The contents distribution site DS can distribute predetermined music content files on demand from the personal computer PC via the communication I/F.

The electronic music apparatus EM is an information processing apparatus having music information processing capabilities; for this apparatus, an automatic play (music reproduction) apparatus or an electronic instrument is used for example. The hardware configuration of the electronic music apparatus EM is the same as that of the personal computer PC; namely, a CPU, a RAM, a ROM, first and second external storage units, an operation input block, and a display output block. However, the electronic music apparatus EM has no capabilities of directly communicating with the contents distribution site DS. In addition, the electronic music apparatus EM has music information processing capabilities that include the capabilities of displaying and outputting the music information for note display and play guide by the display output block as well as a sound output block and a play operation input block, thereby executing sound output capabilities and play operation information input capabilities.

The sound output block is composed of a tone generator circuit, an effecter DSP circuit, and a sound system, outputting the sound based on the sound data and effect control data generated by the music information processing, such as automatic play processing. The play operation input block is composed of a play operation controls, such as a keyboard and a wheel, and a play operation detector circuit, inputting the play operation information about a play operation control 14 detected by the play operation detector circuit into the music information processing block.

The ROM of this electronic music apparatus EM stores the device ID that is unique to this electronic music apparatus EM. In general a device ID is individually allocated to each electronic music apparatus. The device ID is identification information for uniquely identifying an individual electronic music apparatus to discriminate from one another. The allocation method of the device ID is disclosed for example in co-pending U.S. patent application Ser. No. 10/903,725 entitled “method of embedding permanent identification code into music apparatus”. Herein the whole contents of the co-pending U.S. patent application Ser. No. 10/903,725 are incorporated into this specification by specifically referencing to the Ser. No. 10/903,725. A portable external recording medium can be loaded on the second storage unit of the electronic music apparatus EM. The device ID can be written by the second storage unit to the predetermined portable external recording medium usable on the personal computer PC, thereby providing a particular recording medium 5M that can be used to store music content by the side of the personal computer PC.

The particular recording medium 5M written with the device ID of the electronic music apparatus EM is loaded again on the second storage unit of the electronic music apparatus EM after the music content distributed from the contents distribution site DS is written on the side of the personal computer PC. This allows the use of the music content supplied from the contents distribution site DS on the electronic music apparatus EM.

It should be noted that, like the personal computer PC, the electronic music apparatus EM may have a local communication interface (I/F) as required to communicate with the electronic music apparatus EM via wired or wireless local communication medium CM as indicated with dashed lines in FIG. 1. In this case, the music content distributed from the contents distribution site DS may be (1) directly transferred to the electronic music apparatus EM via the local communication medium CM or (2) stored once in the built-in recording medium of the first external storage unit 4 of the personal computer PC before transferring to the electronic music apparatus EM via the local communication medium CM, thereby passing the music content to the electronic music apparatus EM without going through the particular recording medium 5M.

[Processing Flow of Each Apparatus]

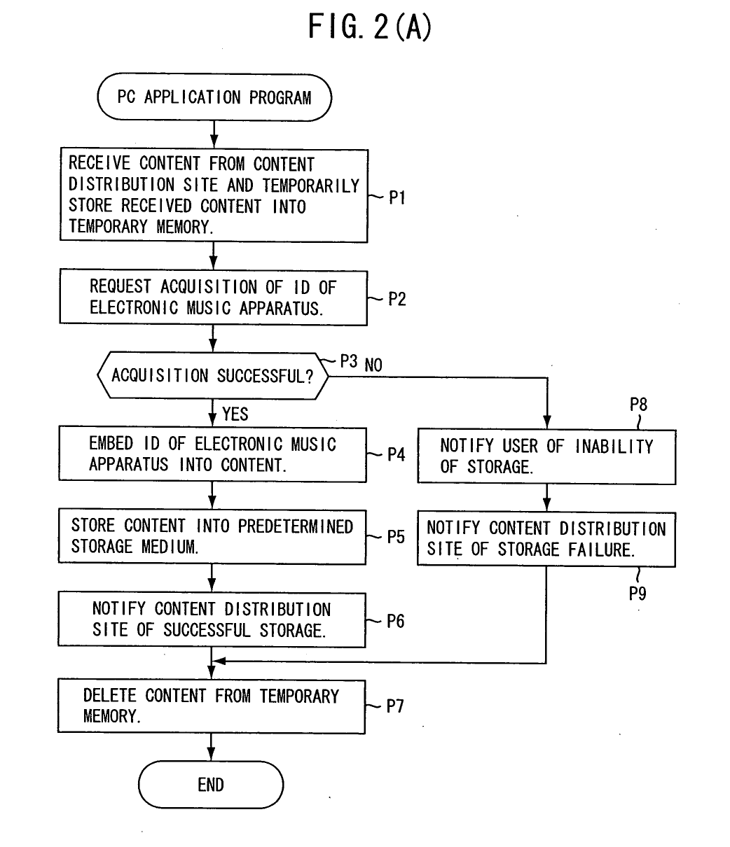

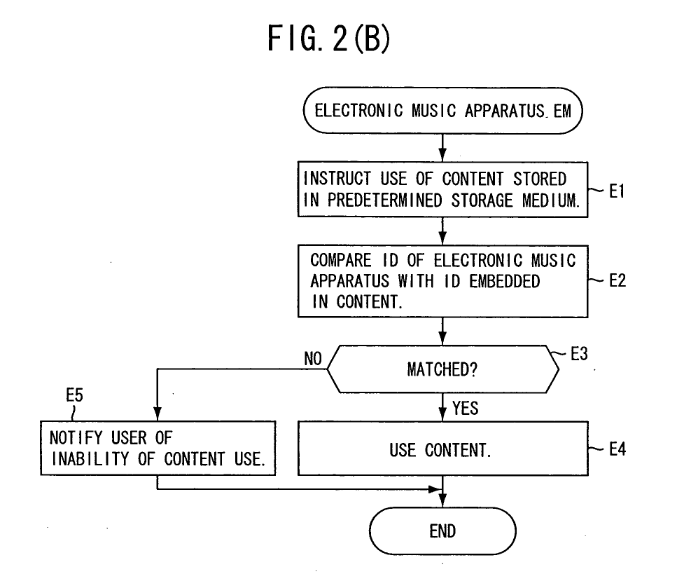

Referring to FIG. 2, there is shown the processing flow of each apparatus constituting the content acquisition system practiced as one embodiment of the invention. The following first outlines the capabilities of this system with reference to FIG. 2. When the content acquisition apparatus (personal computer PC) receives music content from the contents distribution site DS (P1), the personal computer PC requests the acquisition of the device ID unique to the electronic music apparatus EM that uses the received music content (P2). If, in response to this request, the personal computer PC is in the ID acquisition enabled state (for example, the recording media 5M recording the device ID is loaded and the personal computer PC is connected to the electronic music apparatus EM via the local communication medium CM) and has been acquired the device ID of the electronic music apparatus EM (P3→YES), this music content can be acquired. In this case, the device ID is embedded in the music content (P4) and the music content embedded with the device ID is stored in a predetermined recording medium (5M, 4) or transferred to the electronic music apparatus EM (P5). On the other hand, if the personal computer PC is in the ID acquisition disabled state and has not acquired the device ID (P3→NO), the received content is obviously not embedded with the device ID, stored in a recording medium, or transferred to the electronic music apparatus EM (P7 through P9).

The following describes in detail the above-mentioned processing flow with reference to FIG. 2. First, the flowchart shown in the upper portion of the FIG. 2 is indicative of one example of a processing operation to be executed by an application program called “content acquisition program” that is executed by the personal computer PC.

The personal computer PC, operating as directed by the content acquisition program, accesses the contents distribution site DS via the communication interface (I/F) 8 and the communication network CN. When the user-requested content is supplied from the contents distribution site DS, the CPU 1 temporarily stores the music content received from the contents distribution site DS into a temporary memory in the RAM 2 in step P1.

Next, in step P2, the CPU 1 requests the acquisition of the device ID of the electronic music apparatus EM. In step P3, the CPU 1 determines whether the device ID has been acquired. The device ID of the electronic music apparatus EM can be written to the portable external recording medium, or the particular recording medium 5M, in advance by the second external storage unit of the electronic music apparatus EM itself, so that, if the particular recording medium 5M written with the device ID is loaded on the second external storage unit 5 of the personal computer PC, the personal computer PC can acquire the device ID of the electronic music apparatus EM that uses the content by reading the identification information from the particular recording medium. Thus in the inventive information acquisition apparatus, the ID acquisition section acquires the identification information by reading the recording medium 5M.

Therefore, when the acquisition of the device ID is requested (P2) and if the particular recording medium 5M is loaded on the second external storage unit 5 and the device ID has been acquired (P3→YES), the music content concerned can be acquired (or downloaded), followed by the processing operations of steps P4 through P7. 5. Thus the inventive information acquisition apparatus includes a requesting section that is operated to request acquisition of the identification information, so that the ID acquisition section acquires the identification information in response to the request.

Namely, in step P4, the acquired device ID is embedded in the music content temporarily stored in the temporary memory. In step P5, the music content is recorded to and stored in the particular recording medium 5M. When the user-desired music content has been consequently acquired, then, in step P6, the CPU 1 notifies the contents distribution site DS of the successful storage of the music content. In step P7, the music content concerned is deleted from the temporary memory, upon which this application processing operation ends.

On the other hand, if the particular recording medium 5M is not loaded on the second external storage unit 5 and the device ID of the electronic music apparatus EM cannot be acquired (P3→NO), then the procedure goes to step S8, in which a message is displayed on the display 11 telling the user that music content received from the contents distribution site DS and stored in the temporary memory cannot be stored. In step P9, the CPU 1 notifies the contents distribution site DS of the failure of the storage (or acquisition) of the music content. Then, in step P7, the music content is deleted from the temporary memory, upon which this application processing operation ends.

It should be noted that, if the acquisition of the music content fails (P3→NO) and the contents distribution site DS is notified of the failure of the acquisition of the music content, control may be executed so as to make the user retry the acquisition of this music content. In such a case, if charging process has been already executed for the purchase of the music content, the charging process should be canceled because of the failure of the content acquisition. Then, control may be executed so as to prompt the user through notification means, such as the display 11, to load the particular recording medium 5M written with the device ID of the electronic music apparatus EM onto the second external storage unit 5. If the user responds to this prompt by loading the particular recording medium 5M, the procedure returns to step P2.

The flowchart shown in the lower portion of FIG. 2 is indicative of an example of a processing operation to be executed in the electronic music apparatus EM. In the electronic music apparatus EM, the personal computer PC loads the particular recording medium 5M recording and storing music content onto the RAM 2 and, only if the device ID embedded in this music content matches the device ID of the electronic music apparatus EM itself, the user can use this music content. Stated otherwise, the control section of the content acquisition apparatus records the content information embedded with the identification information into a recording medium, which is then loaded into the target electronic musical apparatus, whereby the target electronic musical apparatus can use the content information recorded in the loaded recording medium only if the embedded identification information in the content information matches with unique identification information owned by the target electronic music apparatus.

First, in step E1, when the user specifies the use of music content recorded in the particular recording medium 5M, the CPU of the electronic music apparatus EM extracts the device ID from the specified music content.

In step E2, the CPU reads the device ID of the electronic music apparatus EM itself from the ROM and compares this device ID with the device ID extracted from the music content. If a match is found (E3→YES), then the procedure goes to step E4 to allow the user to use this music content.

In step E4, in which content use is allowed, the music content can be recorded and stored in the built-in recording medium of the first external storage device, the electronic music apparatus EM can be operated in accordance with the music information processing program of the music content, the operation condition for the music information processing can be set in accordance with the instrument setting information of the music content, the sound can be outputted from the sound output block in accordance with the music entity information (such as music data and accompaniment pattern data) of the music content and the play operation information supplied from the play operation input block, or music note display and play guide can be made through the display output block.

On the other hand, if a mismatch is found between both the device IDs (E3→NO), then, in step E5, a message indicative of the inability of use of this music content is displayed on the display of the display output block, thereby telling the user thereof, upon which the processing operation associated with the use of the specified music content ends.

[If the Connection with the Electronic Music Apparatus is Enabled]

In the content acquisition system practiced as one embodiment of the invention, the local communication I/F 12 is arranged on the personal computer PC as indicated by dashed lines in FIG. 1 and the electronic music apparatus EM is also arranged with a local communication I/F, thereby providing communication between the personal computer PC and the electronic music apparatus EM via a wired or wireless local communication medium CM. In this configuration, the personal computer PC can transfer the music content to the electronic music apparatus EM via the local communication medium CM without passing the music content through the particular recording medium 5M.

(1) Direct Transfer of Music Content

In this case, if the personal computer PC and the electronic music apparatus EM are communicable with each other when a request for acquiring the device ID of the electronic music apparatus EM comes in step P2 shown in FIG. 2, the personal computer PC can transfer the information including the device ID with the electronic music apparatus EM via the local communication medium CM, so that the personal computer PC can acquire the device ID from the electronic music apparatus EM (P3→YES) and then transfer the music content embedded with the ID directly to the electronic music apparatus EM via the local communication medium CM also in step P5.

To be more specific, the personal computer PC temporarily stores the music content received from the contents distribution site DS into the temporary memory (P1) and accesses the ROM of the electronic music apparatus EM when requesting the acquisition of the device ID of the electronic music apparatus EM (P2), directly acquiring the device ID from the electronic music apparatus EM. When the acquisition of the device ID of the electronic music apparatus EM is consequently successful (P3→YES), then the personal computer PC embeds the device ID into the music content in step P4. In step S5, the personal computer PC directly transfers the ID-embedded music content to the electronic music apparatus EM. when this transfer processing has been completed, the personal computer PC issues a successful storage notification (P6) and deletes the music content from the temporary memory (P7).

The electronic music apparatus EM records and stores the ID-embedded music content transferred from the personal computer PC into content storage means (in this case, the built-in recording medium of the first external storage unit for example). When the use of this music content is specified by the user in step El shown in FIG. 2, then, in step E2, the electronic music apparatus EM compares the device ID of the electronic music apparatus EM itself with the device ID embedded in the music content. If a match is found (E3→YES), then the procedure goes to step E4, in which the electronic music apparatus EM can use the specified music content.

(2) Indirect Transfer of Music Content

In another embodiment in which the personal computer PC and the electronic music apparatus EM are communicable with each other, “predetermined recording medium” provides the built-in recording medium of the first external storage unit 4 and the same processing operation as the case in which the transfer is made via the particular recording medium 5M is executed, thereby acquiring (or downloading) the music content distributed from the contents distribution site DS, as shown in the flowchart shown in FIG. 2.

To be more specific, if the personal computer PC can access the ROM of the electronic music apparatus EM when requesting the acquisition of the device ID of the electronic music apparatus EM (P2) after temporarily storing the received music content (P1), the personal computer PC can acquire the device ID directly from the ROM of the electronic music apparatus EM. If the personal computer PC and the electronic music apparatus EM are not communicable with each other when the acquisition of the device ID is requested, but the device ID of the electronic music apparatus EM is registered in a predetermined ID storage means (for example, a built-in recording medium of the first external storage unit 4) in the personal computer PC in advance when both the personal computer PC and the electronic music apparatus EM are communicable with each other before, the personal computer PC can get the device ID of the electronic music apparatus EM from this ID storage means. Namely, the inventive information acquisition apparatus includes a storage unit that stores the identification information which is previously provided from the target electronic musical apparatus, so that the ID acquisition section acquires the identification information by reading the storage unit.

Consequently, when the device ID has been successfully acquired from the ROM of the electronic music apparatus EM or the ID storage means of the personal computer PC (P3→YES), the personal computer PC sequentially executes the processing operations of embedding the device ID (P4), storing the ID-embedded music content into the built-in recording medium (P5), notifying the successful storage (P6), and deleting the music content from the temporary memory (P7) in the same manner described above.

When the use of the music content recorded to the built-in recording medium (4) of the personal computer PC is specified (E1), the electronic music apparatus EM compares the device ID embedded in the specified music content with the device ID of the electronic music apparatus EM itself (E2). Only if a match is found (E3→YES), the music content is transferred to a predetermined storage means (the RAM or the built-in recording medium of the first external storage unit) via the local communication medium CM, and the transferred music content can be used in the electronic music apparatus EM (E4).

It should be noted that if the music content is stored in the built-in recording medium (4) of the personal computer PC, it may be configured that this music content be automatically deleted by the personal computer PC notified of the successful storage when this music content has been stored in a content storage means (for example, the built-in recording medium of the first external storage unit) of the electronic music apparatus EM.

In this example of indirect transfer, when the device ID of the electronic music apparatus EM has been successfully acquired (P3→YES), the music content can be once stored in the built-in recording medium of he first external storage unit 4, thereby providing a match in copy count with the case in which the music content is stored in the particular recording medium 5M, which overcomes a problem in the copyright protection of the music content. Also, the acquisition of the device ID of the electronic music apparatus EM from the ID storage means (4) eliminates the necessity for both the personal computer PC and the electronic music apparatus EM to be communicable with each other at the time of music content distribution.

(3) Supplementary Information (Processing to be Executed at Failure of ID Acquisition for Example)

In the system where both the personal computer PC and the electronic music apparatus EM have the local communication I/F of common specification as indicated by dashed lines in FIG. 1, if the device ID of the electronic music apparatus EM has not been acquired (P3→NO) owing to that the particular recording medium 5M is not loaded on the second external storage unit 5, or owing to that the access to the ROM for example of the electronic music apparatus EM is disabled (due to cable CM connection failure, the electronic music apparatus EM not powered, or ROM access disabled, for example), or owing to that the device ID has not been registered in the ID storage means, the device ID could not be embedded into the music content. Further, the music content temporarily stored in the temporary memory without the device ID will not be stored in a predetermined recording medium (5M, 4) or transferred to the electronic music apparatus EM. In this case, as with the description of the system in which the particular recording medium 5M is used, the inability of content storage is notified (P8), the contents distribution site DS is notified of the failure of content storage (or acquisition) (P5), and the music content is deleted from the temporary memory to end the processing operation (P7). Namely, the control section discards the received content information when the ID acquisition section fails to acquire the identification information in response to the request.

If the failure of content acquisition is notified (P9), the user may be prompted to get the device ID of the electronic music apparatus as described above with the system in which the particular recording medium 5M is used. For example, in addition to prompting the user to load the particular recording medium 5M written with the device ID of the electronic music apparatus EM as described above, the user may be prompted to correctly connect the personal computer PC to the electronic music apparatus EM with a cable for example. In this case, when the user responds, then (after returning to step P2), an attempt is made again to get the ID of the electronic music apparatus EM.

It should be noted that, if there are two or more destinations that acquires the device ID (namely, in the case of a system in which the device ID can be acquired from any of the particular recording medium 5M, the ROM of the electronic music apparatus EM, and the ID storage means of the personal computer PC), the selection of the destination of device ID acquisition and the destinations of music content storage and transfer may be set in advance or left to user discretion.

### OTHER EMBODIMENTS

So far, one embodiment of the present invention has been described. Various modifications and alterations may be made thereto and are practicable in various embodiments. For example, in the above-mentioned embodiment, a system is provided in which a content acquisition apparatus (PC) and an electronic music apparatus (EM) transfer the device ID of the electronic music apparatus (EM) and the content therefor between these apparatuses via a predetermined portable external recording medium (particular recording medium 5M) and a local communication medium (CM), for example. Alternatively, the transfer of information may be executed between these apparatuses (PC and EM) only via a local communication medium (CM) without using the particular recording medium (5M).

In the electronic music apparatus EM, the device ID thereof may be stored in a built-in recording medium of the first external storage unit for example other than the ROM. In this case, preferably, the device ID is stored in an area that is not accessible by the user so as to prevent the alteration or unauthorized acquisition of the device ID.

The device ID may be embedded in music content by means of watermarking, converting the device ID into part or all of an encryption key, or writing the device ID to an encrypted portion in music content.

1. An information acquisition apparatus capable of associating with a target electronic music apparatus and capable of acquiring content information representing a music content from a contents distribution site for use in the target electronic music apparatus, the information acquisition apparatus comprising:
an information reception section that receives content information representing a music content desired for use in the target electronic music apparatus from the contents distribution site through a communication line;
an ID acquisition section that acquires identification information which uniquely identifies the target electronic music apparatus to discriminate from other electronic music apparatuses;
an embedding section that embeds the acquired identification information into the received content information; and
a control section that records the content information embedded with the identification information into a recording medium for use in the target electronic musical apparatus.

2. The information acquisition apparatus according to claim 1, wherein the control section records the content information into a recording medium which is previously recorded with the identification information of the target electronic musical apparatus, and wherein the ID acquisition section acquires the identification information by reading the recording medium.

3. The information acquisition apparatus according to claim 1, further comprising a storage unit that stores the identification information which is previously provided from the target electronic musical apparatus, wherein the ID acquisition section acquires the identification information by reading the storage unit.

4. The information acquisition apparatus according to claim 1, wherein the control section records the content information embedded with the identification information into a recording medium, which is then loaded into the target electronic musical apparatus, whereby the target electronic musical apparatus can use the content information recorded in the loaded recording medium only if the embedded identification information in the content information matches with unique identification information owned by the target electronic music apparatus.

5. The information acquisition apparatus according to claim 1, further comprising a requesting section that is operated to request acquisition of the identification information, so that the ID acquisition section acquires the identification information in response to the request.

6. The information acquisition apparatus according to claim 5, wherein the control section discards the received content information when the ID acquisition section fails to acquire the identification information in response to the request.

7. An information acquisition apparatus capable of communicating with a target electronic music apparatus and capable of acquiring content information representing a music content from a contents distribution site for use in the target electronic music apparatus, the information acquisition apparatus comprising:
an information reception section that receives content information representing a music content desired for use in the target electronic music apparatus from the contents distribution site through a communication line;
an ID acquisition section that acquires identification information which uniquely identifies the target electronic music apparatus to discriminate from other electronic music apparatuses;
an embedding section that embeds the acquired identification information into the received content information; and
a transmission section that transmits the content information embedded with the identification information to the target electronic musical apparatus.

8. The information acquisition apparatus according to claim 7, further comprising a requesting section that requests the identification information to the target electronic music apparatus, so that the ID acquisition section acquires the identification information which is sent from the target electronic music apparatus in response to the request.

9. The information acquisition apparatus according to claim 8, further comprising a control section that discards the received content information when the ID acquisition section fails to acquire the identification information in response to the request.

10. The information acquisition apparatus according to claim 7, wherein the transmission section transmits the content information embedded with the identification information to the target electronic musical apparatus, whereby the target electronic musical apparatus can use the transmitted content information if the embedded identification information in the content information matches with unique identification information owned by the target electronic music apparatus.

11. A computer program for use in an information acquisition apparatus capable of associating with a target electronic music apparatus and capable of acquiring content information representing a music content from a contents distribution site for use in the target electronic music apparatus, the computer program being executable by a processor of the information acquisition apparatus to perform a method comprising the steps of:
receiving content information representing a music content desired for use in the target electronic music apparatus from the contents distribution site through a communication line;
acquiring identification information which uniquely identifies the target electronic music apparatus to discriminate from other electronic music apparatuses;
embedding the acquired identification information into the received content information; and
recording the content information embedded with the identification information into a recording medium for use in the target electronic musical apparatus.

12. A computer program for use in an information acquisition apparatus capable of communicating with a target electronic music apparatus and capable of acquiring content information representing a music content from a contents distribution site for use in the target electronic music apparatus, the computer program being executable by a processor of the information acquisition apparatus for performing a method comprising the steps of:
receiving content information representing a music content desired for use in the target electronic music apparatus from the contents distribution site through a communication line;
acquiring identification information which uniquely identifies the target electronic music apparatus to discriminate from other electronic music apparatuses;
embedding the acquired identification information into the received content information; and
transmitting the content information embedded with the identification information to the target electronic musical apparatus.
